(19) United States
(12) Patent Application Publication
(10) Pub. No.: US 2026/0254161 A1
(43) Pub. Date: Aug. 27, 2026

(54) CONNECTOR

(71) Applicant: SUMITOMO WIRING SYSTEMS, LTD., Mie (JP)

(72) Inventors: Kuniaki TANIDA, Mie (JP); Kazuo NAKAI, Mie (JP)

(21) Appl. No.: 19/547,209

(22) Filed: Feb. 23, 2026

(30) Foreign Application Priority Data
Feb. 26, 2025 (JP) 2025-028942

(51) Int. Cl. H01R 13/627; H01R 13/629; H01R 24/20; H01R 24/62

(52) U.S. Cl. CPC H01R 13/6272; H01R 13/629; H01R 24/20; H01R 24/62

(57) ABSTRACT

A first connector includes a first housing and a first terminal fitting held in the first housing. The first housing includes a housing body for accommodating the first terminal fitting inside, and a fitting tube portion surrounding the outer periphery of the housing body. The first housing includes a lock arm provided further in an upward direction than an outer surface in the upward direction of the housing body and a separating portion provided on an outer surface in a downward direction of the housing body. The separating portion includes a projecting portion projecting in the downward direction. The projecting portion is provided further in a rearward direction than the fitting tube portion. The projecting portion has a first surface facing in a forward direction. The first surface is formed into an arcuately curved surface concave in the rearward direction when viewed from the downward direction.

### CROSS-REFERENCE TO RELATED APPLICATIONS

This application is based on and claims priority from Japanese Patent Application No. 2025-028942, filed on February 26, 2025, with the Japan Patent Office, the disclosure of which is incorporated herein in its entirety by reference.

### TECHNICAL FIELD

The present invention relates to a connector.

### BACKGROUND

Conventionally, a connector to be installed in a vehicle is provided with a male connector and a female connector connectable to each other (see, for example, Japanese Patent Laid-open Publication No. 2007-305415). The female connector is provided with a terminal accommodating portion and a fitting tube portion surrounding the outer periphery of the terminal accommodating portion. A deflectable and deformable lock arm is coupled to the terminal accommodating portion. Further, a finger hooking portion is provided on the outer surface of the terminal accommodating portion. The male connector is provided with a receptacle, into which the fitting tube portion is fittable, and a lock receiving portion provided to project from the upper surface of the receptacle. In the connector of this type, a connected state of the male connector and the female connector is maintained by engaging the lock arm with the lock receiving portion. Further, in the above connector, in separating the female connector from the male connector, an operation of pulling the female connector apart from the male connector can be performed by hooking a finger on the finger hooking portion.

### SUMMARY

In the above connector, it is desired to improve workability in separating the female connector from the male connector.

The present disclosure aims to provide a connector capable of improving workability at the time of separation.

The present disclosure is directed to a connector with a first connector including a first housing and a first terminal fitting held in the first housing, the first housing including a housing body for accommodating the first terminal fitting inside, a fitting tube portion surrounding an outer periphery of the housing body, a lock arm provided at a position further in a first direction than a first outer surface of the housing body, and a separating portion provided on a second outer surface opposite to the first outer surface, out of the housing body, the separating portion including a projecting portion projecting in a first opposite direction opposite to the first direction, the projecting portion being provided at a position further in a second direction intersecting the first direction than the fitting tube portion, the projecting portion having a first surface facing in a second opposite direction opposite to the second direction, and the first surface being formed into an arcuately curved surface concave in the second direction when viewed from the first opposite direction.

According to the connector of the present disclosure, an effect of being able to improve workability at the time of separation is achieved.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view showing a connector of one embodiment.

FIG. 2 is an exploded perspective view showing the connector of the embodiment.

FIG. 3 is a section showing the connector of the embodiment (section along 3-3 in FIG. 4).

FIG. 4 is a back view showing the connector of the embodiment.

FIG. 5 is a perspective view showing a first connector of the embodiment.

FIG. 6 is a plan view showing the connector of the embodiment.

FIG. 7 is a section enlargedly showing a part of the connector of the embodiment (section along 7-7 in FIG. 4).

FIG. 8 is a perspective view showing the connector of the embodiment.

FIG. 9 is a side view showing a function of the connector of the embodiment.

FIG. 10 is a plan view showing the function of the connector of the embodiment.

FIG. 11 is a perspective view showing the function of the connector of the embodiment.

FIG. 12 is a side view showing the function of the connector of the embodiment.

FIG. 13 is a side view showing the function of the connector of the embodiment.

FIG. 14 is a back view showing the function of the connector of the embodiment.

FIG. 15 is a perspective view showing an application example of the connector of the embodiment.

FIG. 16 is an exploded perspective view showing the application example of the connector of the embodiment.

FIG. 17 is a section showing the application example of the connector of the embodiment.

FIG. 18 is a section showing the application example of the connector of the embodiment.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### Description of Embodiments of Present Disclosure

First, embodiments of the present disclosure are listed and described.

[1] The connector of the present disclosure is provided with a first connector including a first housing and a first terminal fitting held in the first housing, the first housing including a housing body for accommodating the first terminal fitting inside, a fitting tube portion surrounding an outer periphery of the housing body, a lock arm provided at a position further in a first direction than a first outer surface of the housing body, and a separating portion provided on a second outer surface opposite to the first outer surface, out of the housing body, the separating portion including a projecting portion projecting in a first opposite direction opposite to the first direction, the projecting portion being provided at a position further in a second direction intersecting the first direction than the fitting tube portion, the projecting portion having a first surface facing in a second opposite direction opposite to the second direction, and the first surface being formed into an arcuately curved surface concave in the second direction when viewed from the first opposite direction.

According to this configuration, the separating portion provided on the second outer surface of the housing body includes the projecting portion provided at the position further in the second direction than the fitting tube portion. The first surface facing in the second opposite direction, out of the projecting portion, i.e. the first surface facing the fitting tube portion, is formed into the curved surface concave in the second direction (i.e. concave curved surface). Thus, when the first housing is pulled in the second direction, for example, with a finger hooked on the projecting portion, the pad of the finger can be widely brought into contact with the first surface, which is the concave curved surface. In this way, a load applied to the finger can be dispersed when the first housing is pulled in the second direction, and the application of a biased load to the finger can be suppressed. As a result, the occurrence of a problem that the finger hurts when the first housing is pulled in the second direction can be suitably suppressed, wherefore workability in separating the first connector can be improved.

[2] In [1] described above, the projecting portion may have a width extending along a third direction intersecting both the first direction and the second direction, and the first surface may be formed into a curved surface having a recess amount in the second direction increasing toward a center in the third direction.

According to this configuration, the first surface of the projecting portion is formed to increase the recess amount in the second direction toward the center in a width direction of the projecting portion. Thus, a central part of the pad of the finger can be suitably brought into contact with the center in the width direction of the first surface when the finger is hooked on the projecting portion. In this way, the finger can be suitably hooked on the projecting portion. Therefore, the first housing can be stably pulled in the second direction with the finger hooked on the projecting portion.

[3] In [2] described above, the projecting portion may have a second surface facing in the first opposite direction, and the second surface may be formed into an arcuately curved surface concave in the first direction when viewed from the second direction.

According to this configuration, the second surface facing in the first opposite direction, out of the projecting portion, is formed into the curved surface concave in the first direction. Thus, when the first housing is pulled in the second direction, for example, with the lock arm and the projecting portion sandwiched and pinched by two fingers, a tip part of the pad of the finger can be widely brought into contact with the second surface, which is the concave curved surface. In this way, a load applied to the finger can be dispersed when the first housing is pulled in the second direction, and the application of a biased load to the finger can be suppressed.

[4] In [3] described above, the projecting portion may have a third surface provided on a corner part between the first surface and the second surface, and the third surface may be formed into an arcuately curved surface concave in the second direction when viewed from the first opposite direction.

According to this configuration, the third surface provided on the corner part between the first surface and the second surface is formed into the curved surface concave in the second direction. Thus, when the first housing is pulled in the second direction, for example, with a finger hooked on the projecting portion, the pad of the finger can be widely brought into contact with the third surface and the first surface, which are the concave curved surfaces. In this way, a load applied to the finger can be dispersed when the first housing is pulled in the second direction, and the application of a biased load to the finger can be suppressed.

[5] In [3] or [4] described above, the separating portion may include a projecting base provided on the second outer surface, the projecting portion projecting in the first opposite direction from an end surface in the first opposite direction of the projecting base and a groove portion recessed in the first direction from the end surface in the first opposite direction of the projecting base, the first surface may be formed to be inclined toward the second direction from the end surface in the first opposite direction of the projecting base toward the second surface, an axial direction of the groove portion may extend along the second direction, the groove portion may extend to the projecting portion to divide the first surface in the third direction, and a first inner surface facing in the second opposite direction, out of the groove portion, may extend orthogonally to the second direction.

According to this configuration, the separating portion is constituted by the projecting base, the projecting portion projecting in the first opposite direction from the projecting base and the groove portion provided in the end surface in the first opposite direction of the projecting base. At this time, the first surface facing in the second opposite direction, out of the projecting portion, is formed into an inclined surface. Further, the first inner surface facing in the second opposite direction, out of the groove portion dividing the first surface, is formed to be orthogonal to the axial direction of the groove portion.

[6] In [5] described above, a wire cover to be mounted on the outer periphery of the housing body may be further provided, the wire cover may include a ridge portion to be fit into the groove portion, a length direction of the ridge portion may extend along the second direction, and a first end surface facing in the second direction, out of the ridge portion, may be formed to extend orthogonally to the second direction and be engageable with the first inner surface of the groove portion.

According to this configuration, when the wire cover is mounted on the outer periphery of the housing body, the ridge portion of the wire cover is fit into the groove portion of the separating portion. The first end surface of the ridge portion formed to be orthogonal to the second direction and the first inner surface of the groove portion are formed to be engageable with each other. In this way, if the wire cover is pulled in the second direction, the housing body can be pulled in the second direction, together with the wire cover, by the engagement of the first end surface and the first inner surface. Thus, a separating operation of the first connector can be performed with the wire cover mounted on the housing body. As a result, an operation of removing the wire cover from the housing body can be omitted, wherefore workability in separating the first connector can be improved as compared to the case where an operation of removing the wire cover is necessary in separating the first connector.

[7] In any one of [1] to [6] described above, a second connector may be further provided, the first connector being attached to and detached from the second connector, the second connector may include a second housing to be fit to the first housing and a second terminal fitting to be electrically connected to the first terminal fitting, and the second housing may include a receptacle to be fit between the housing body and the fitting tube portion and a lock protrusion projecting from an outer surface of the receptacle and engageable with the lock arm.

According to this configuration, as in [1] described above, workability can be improved in separating the first connector from the second connector.

### Details of Embodiment of Present Disclosure

A specific example of a connector of the present disclosure is described below with reference to the drawings. For the convenience of description, some components may be shown in an exaggerated or simplified manner in each drawing. Further, a dimension ratio of each part may be different in each drawing. Further, "parallel", "orthogonal" and "perpendicular" in this specification mean not only strictly parallel, orthogonal and perpendicular, but also substantially parallel, orthogonal and perpendicular within a range in which function and effects in this embodiment are achieved. A term "tubular" used in the description of this specification indicates not only a shape formed by a peripheral wall continuous over an entire periphery in a circumferential direction, but also a tubular shape formed by combining a plurality of components and a shape having a cut or the like in a circumferential part such as a C shape. Note that "tubular" shapes include circular shapes, elliptical shapes and polygonal shapes with angular or rounded corners, but there is no limitation to these. "Facing each other" in this specification indicates that surfaces or members are at positions in front of each other. "Facing each other" in this specification means not only a case where the surfaces or members are at positions perfectly in front of each other, but also a case where the surfaces or members are partially in front of each other. Further, "facing each other" in this specification means both a case where another member different from two parts is interposed between the two parts and a case where nothing is interposed between the two part. Further, terms such as "first", "second" and "third" in this specification are merely used to distinguish objects and do not rank the objects. Note that the present invention is not limited to these illustrations, but is represented by claims and intended to include all changes in the scope of claims and in the meaning and scope of equivalents.

### Overall Configuration of Connector 10

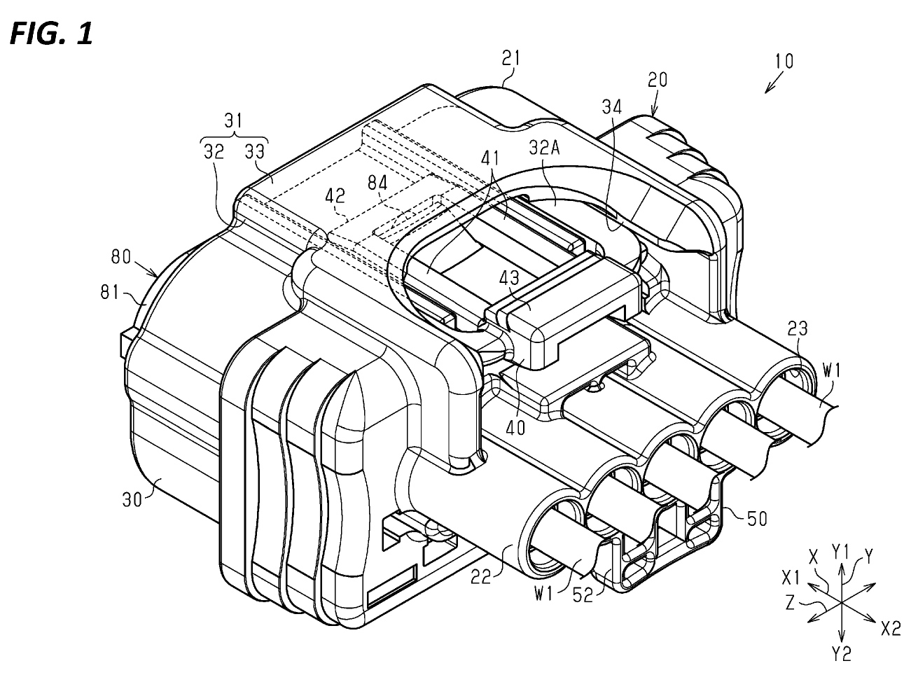

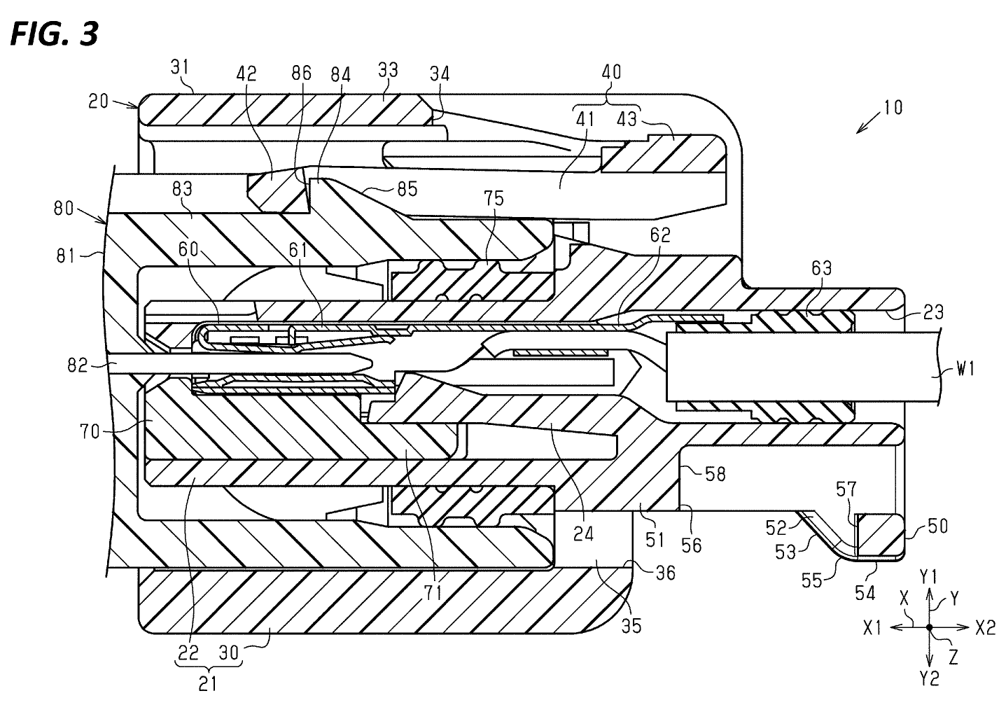

As shown in FIGS. 1 to 3, the connector 10 is provided with a first connector 20 and a second connector 80, to and from which the first connector 20 is attached and removed. The connector 10 is a waterproof connector. The first connector 20 of this embodiment is a female connector. The second connector 80 of this embodiment is a male connector. The second connector 80 is, for example, directly connected to an unillustrated device. As shown in FIG. 3, the first connector 20 includes a first housing 21 and first terminal fittings 60 held in the first housing 21. The second connector 80 includes a second housing 81 fittable to the first housing 21 and second terminal fittings 82 held in the second housing 81. In the connector 10, the first terminal fittings 60 and the second terminal fittings 82 are electrically connected by fitting the first housing 21 to the second housing 81.

Here, a first axis X, a second axis Y orthogonal to the first axis X and a third axis Z orthogonal to both the first axis X and the second axis Y are shown in each figure. A length direction of the connector 10 extends along the first axis X. A forward direction X1 along the first axis X and a rearward direction X2 opposite to the forward direction X1 are shown in each figure. Here, the forward direction X1 is a forward direction along a connection direction of the first connector 20 to the second connector 80. A height direction of the connector 10 extends along the second axis Y. An upward direction Y1 along the second axis Y and a downward direction Y2 opposite to the upward direction Y1 are shown in each figure. A width direction of the connector 10 extends along the third axis Z. Note that the connector 10 can be arranged in an arbitrary orientation and is not necessarily used in such a posture that the upward direction Y1 is facing upward.

### Configuration of Second Connector 80

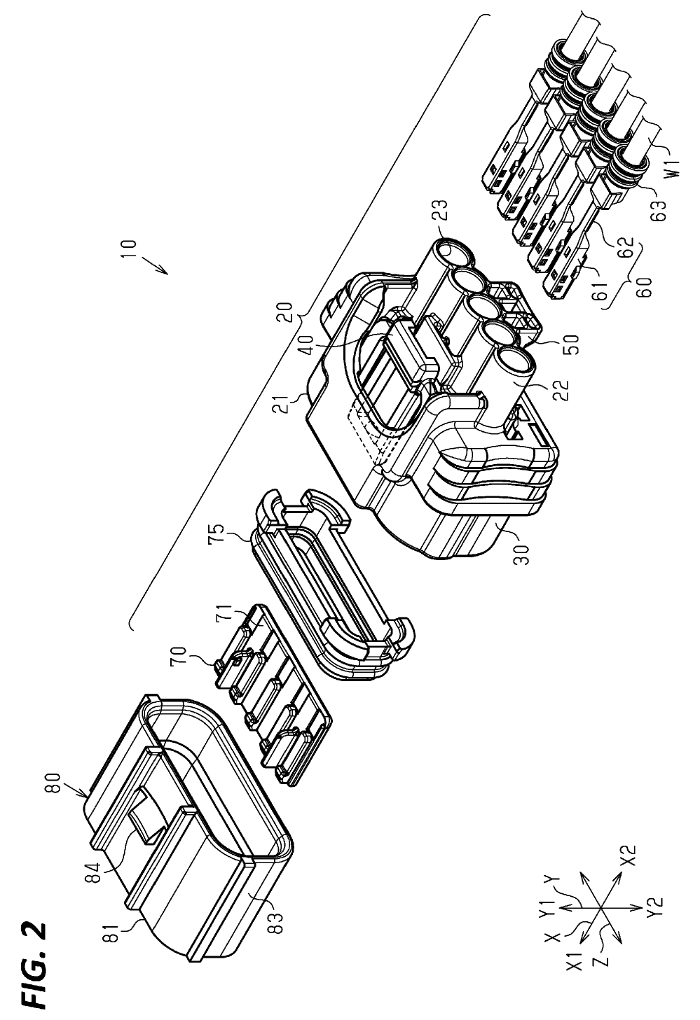

As shown in FIG. 2, the second housing 81 includes a tubular receptacle 83 and a lock protrusion 84 projecting in the upward direction Y1 from the outer surface in the upward direction Y1 of the receptacle 83. The second housing 81 is a single component in which the receptacle 83 and the lock protrusion 84 are continuously and integrally formed. The second housing 81 is made of synthetic resin. Note that only a part of the second housing 81 is shown in each figure.

The receptacle 83 is formed into a flat shape longer in the third axis Z than in the second axis Y. The receptacle 83 is open in the rearward direction X2.

As shown in FIG. 3, the lock protrusion 84 has an inclined surface 85 and an engaging surface 86. The inclined surface 85 is formed to be inclined toward the forward direction X1 as approaching an end part in the upward direction Y1 of the engaging surface 86 from the outer surface in the upward direction Y1 of the receptacle 83. The engaging surface 86 is formed to be orthogonal to the forward direction X1, which is the connection direction of the first connector 20 to the second connector 80. The engaging surface 86 of this embodiment is formed to extend perpendicularly from the outer surface in the upward direction Y1 of the receptacle 83. The engaging surface 86 is provided on an end surface in the forward direction X1 of the lock protrusion 84.

A plurality of (only one is shown in FIG. 3) second terminal fittings 82 are arranged to project inside the receptacle 83. Although not shown in detail, the plurality of second terminal fittings 82 are arranged side by side in a row along the third axis Z inside the receptacle 83. Each second terminal fitting 82 is a pin-like or tab-like male terminal fitting.

### Configuration of First Connector 20

As shown in FIG. 2, the first connector 20 includes the first housing 21, a plurality of (five in this embodiment) first terminal fittings 60, a retainer 70 and a sealing member 75. The plurality of first terminal fittings 60 are arranged side by side in a row along the third axis Z. Each first terminal fitting 60 is inserted into the inside of the first housing 21 along the forward direction X1.

### Configuration of First Housing 21

As shown in FIGS. 2 to 4, the first housing 21 includes a housing body 22, a tubular fitting tube portion 30 surrounding the outer periphery of the housing body 22, a lock arm 40 and a separating portion 50. The first housing 21 is a single component in which the housing body 22, the tubular fitting tube portion 30, the lock arm 40 and the separating portion 50 are continuously and integrally formed. The first housing 21 is made of synthetic resin.

As shown in FIG. 2, the housing body 22 accommodates the plurality of first terminal fittings 60 inside. The housing body 22 includes a plurality of (five in this embodiment) cavities 23. The five cavities 23 are arranged side by side in a row along the third axis Z. Each first terminal fitting 60 is inserted into each cavity 23 along the forward direction X1. The five cavities 23 respectively individually accommodate the five first terminal fittings 60.

As shown in FIG. 3, each cavity 23 penetrates through the housing body 22 along the first axis X. A locking lance 24 having a cantilever shape is provided inside each cavity 23. The locking lance 24 is formed to be deflectable and deformable. The locking lance 24 has a function of preventing the first terminal fitting 60 from coming out from the cavity 23 by being resiliently engaged with the first terminal fitting 60.

Here, each first terminal fitting 60 is connected to an end part of a wire W1. Each first terminal fitting 60 is a female terminal fitting including a female terminal portion 61 and a wire connecting portion 62. Each first terminal fitting 60 is such that the female terminal portion 61 and the wire connecting portion 62 are continuously and integrally formed. The female terminal portion 61 is formed into a tubular shape capable of accommodating the second terminal fitting 82 inside. The wire connecting portion 62 is crimped to a core wire of the wire W1 and crimped to a rubber plug 63 mounted on the outer peripheral surface of the wire W1. The rubber plug 63 is mounted on the outer peripheral surface of the end part of the wire W1 to be held in close contact with the inner peripheral surface of the cavity 23. Note that each wire W1 is pulled out to the outside of the housing body 22 from an end part in the rearward direction X2 of the cavity 23.

The retainer 70 is assembled with an end part in the forward direction X1 of the housing body 22 along the rearward direction X2. The retainer 70 includes a restricting portion 71 to be inserted into the cavities 23 and inserted below the locking lances 24. The restricting portion 71 restricts the deflection and deformation of the locking lances 24 by contacting the locking lances 24 from the downward direction Y2. Note that the retainer 70 is made of synthetic resin.

The housing body 22 is fit into the receptacle 83 of the second housing 81 when the first and second connectors 20, 80 are connected. The sealing member 75 is mounted on the outer peripheral surface of the housing body 22. The sealing member 75 is formed into a ring shape along the outer peripheral surface of the housing body 22. The sealing member 75 is arranged in a resiliently compressed state between the outer peripheral surface of the housing body 22 and the inner peripheral surface of the receptacle 83 with the connection of the first housing 21 and the second housing 81 completed. In this way, liquid-tight sealing is provided between the first housing 21 and the second housing 81. Note that the sealing member 75 is made of rubber.

### Configuration of Fitting Tube Portion 30

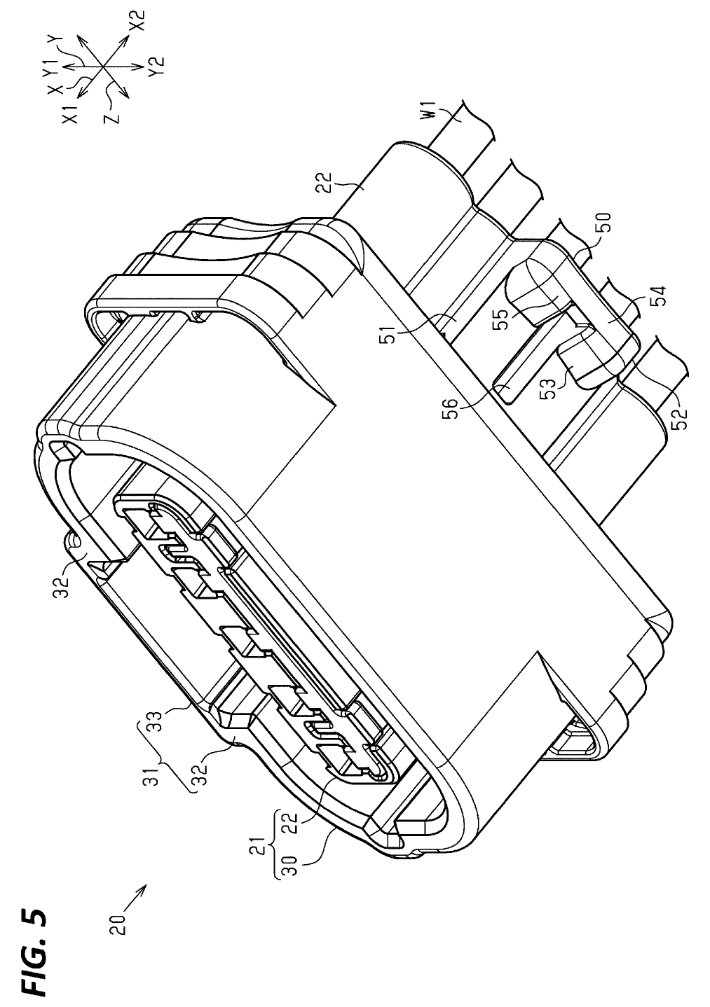

As shown in FIG. 5, the fitting tube portion 30 is formed to surround the outer periphery of the housing body 22 over an entire periphery in a circumferential direction. The fitting tube portion 30 is formed into a flat shape longer in the third axis Z than in the second axis Y. A bulging portion 31 bulging in the upward direction Y1 is provided on a peripheral wall in the upward direction Y1 of the fitting tube portion 30. The bulging portion 31 includes a pair of wall portions 32 facing each other in the third axis Z and a covering wall 33 for covering the housing body 22 between the pair of wall portions 32 from the upward direction Y1. As shown in FIG. 1, each wall portion 32 extends in the rearward direction X2 from an end part in the forward direction X1 of the fitting tube portion 30. An end part in the rearward direction X2 of each wall portion 32 is formed to be connected to an end surface in the upward direction Y1 of the housing body 22. The covering wall 33 is formed to couple the end parts in the upward direction Y1 of the pair of wall portions 32. The covering wall 33 is provided with a cut portion 34 formed by cutting an end part in the rearward direction X2 of the covering wall 33.

As shown in FIG. 3, the fitting tube portion 30 is externally fit to the receptacle 83 of the second housing 81 when the first and second connectors 20, 80 are connected.

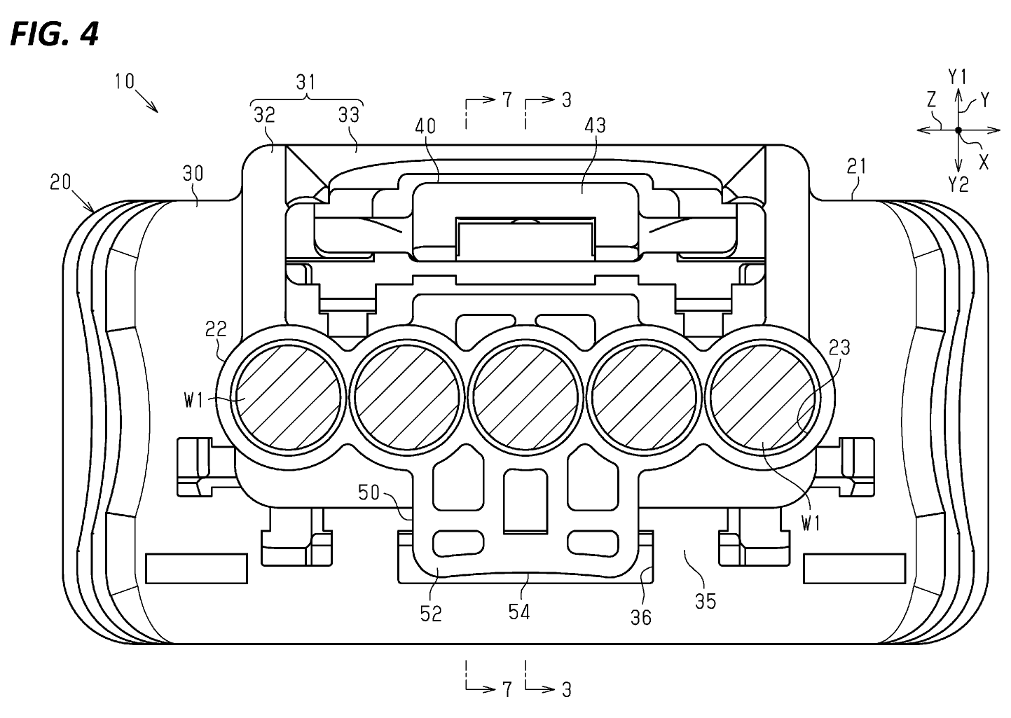

A coupling wall 35 coupling the fitting tube portion 30 and the housing body 22 is provided on the end part in the rearward direction X2 of the fitting tube portion 30. As shown in FIG. 4, the coupling wall 35 is provided with an opening 36. The opening 36 is provided at a position overlapping the separating portion 50 when viewed from a direction along the first axis X. The opening 36 extends along the third axis Z. A dimension along the third axis Z of the opening 36 is larger than that of the separating portion 50. As shown in FIG. 3, the opening 36 is formed to penetrate through the coupling wall 35 along the first axis X.

### Configuration of Lock Arm 40

As shown in FIG. 1, the lock arm 40 is provided further in the upward direction Y1 than the outer surface (first outer surface) in the upward direction Y1 of the housing body 22. The lock arm 40 is, for example, provided inside the bulging portion 31. The lock arm 40 is arranged between the housing body 22 and the covering wall 33 of the bulging portion 31 in the second axis Y.

The lock arm 40 includes a pair of arms 41 extending along the first axis X, a lock portion 42 coupling end parts in the forward direction X1 of the pair of arms 41, and an operating portion 43 coupling end parts in the rearward direction X2 of the pair of arms 41. The pair of arms 41 are provided to face each other in the third axis Z. Although not shown in detail, the pair of arms 41 are coupled to extending portions 32A extending from the pair of wall portions 32. The extending portion 32A of this embodiment is coupled to a part to be connected to the operating portion 43, out of the arm 41. The lock arm 40 is deflectable and deformable in a direction along the second axis Y with a coupling part of the arms 41 and the extending portions 32A, i.e. the operating portion 43, as a fulcrum. As shown in FIG. 3, an end surface in the rearward direction X2 of the lock portion 42 is formed to be engageable with the engaging surface 86 of the lock protrusion 84. The operating portion 43 is provided at a position overlapping the cut portion 34 when viewed from the upward direction Y1. The operating portion 43 is, for example, pressed in the downward direction Y2 by an operator’s finger. The lock arm 40 is deflected and deformed with the operating portion 43 as a fulcrum if the operating portion 43 is pressed. In this way, the engaged state of the lock portion 42 and the lock protrusion 84 is released and the first housing 21 can be separated from the second housing 81.

### Configuration of Separating Portion 50

As shown in FIG. 5, the separating portion 50 is provided on the outer surface (second outer surface) in the downward direction Y2 of the housing body 22. The separating portion 50 is provided at a center position in a width direction of the housing body 22 (here, a direction along the third axis Z).

The separating portion 50 is provided at a position further in the rearward direction X2 than the fitting tube portion 30. That is, the separating portion 50 is provided on the outer surface of a part of the housing body 22 exposed from the fitting tube portion 30.

The separating portion 50 includes a projecting base 51 formed on the outer surface in the downward direction Y2 of the housing body 22 and a projecting portion 52 projecting in the downward direction Y2 from an end surface in the downward direction Y2 of the projecting base 51.

The projecting base 51 is formed to protrude in the downward direction Y2 from the outer surface in the downward direction Y2 of the housing body 22. The projecting base 51 extends from an end edge in the rearward direction X2 of the housing body 22 to the fitting tube portion 30 along the first axis X. A width direction of the projecting base 51 extends along the third axis Z. The end surface in the downward direction Y2 of the projecting base 51 is formed into a flat surface as a whole.

The projecting portion 52 is provided on an end part in the rearward direction X2 of the projecting base 51. The projecting portion 52 is provided only on a part of the projecting base 51 in the first axis X. The projecting portion 52 is formed to extend over the entire length in the width direction of the projecting base 51. A width direction of the projecting portion 52 extends along the third axis Z. The projecting portion 52 has a first surface 53 facing in the forward direction X1, a second surface 54 facing in the downward direction Y2 and a third surface 35 provided between the first and second surfaces 53, 54.

As shown in FIG. 3, the first surface 53 is facing toward the fitting tube portion 30. The first surface 53 is formed to extend from the end surface in the downward direction Y2 of the projecting base 51 to the third surface 55. The first surface 53 is formed to be inclined toward the rearward direction X2 as approaching the third surface 55 from the end surface in the downward direction Y2 of the projecting base 51.

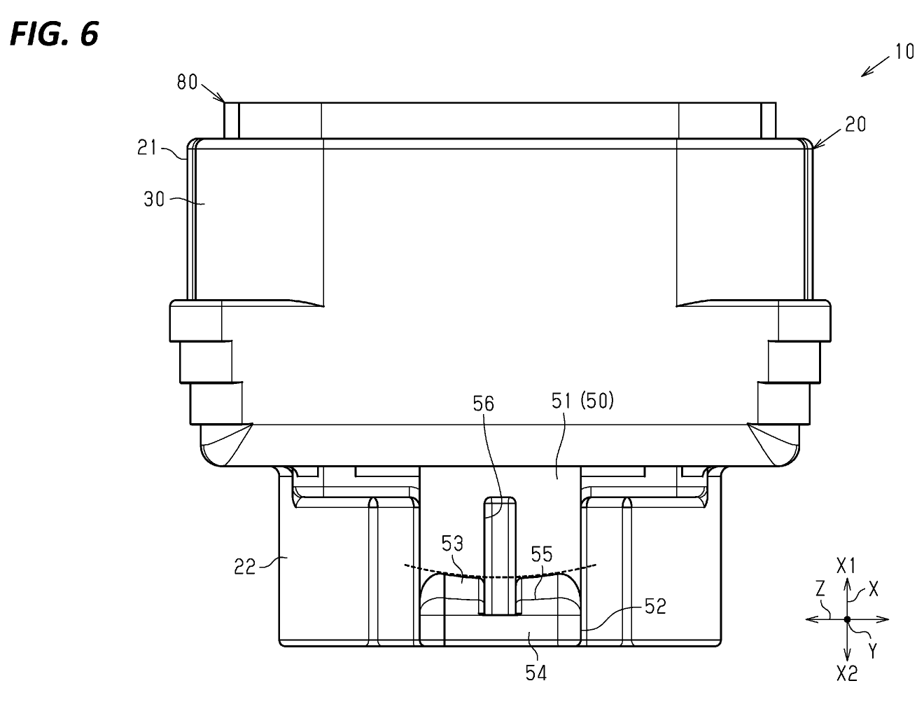

As shown in FIG. 6, the first surface 53 is formed into a curved surface curved when viewed from a direction along the second axis Y (see a broken line in FIG. 6). The first surface 53 is formed into an arcuately curved surface concave in the rearward direction X2. The first surface 53 is formed into a curved surface having a recess amount in the rearward direction X2 increasing as approaching a center in the width direction of the projecting portion 52 (direction along the third axis Z).

As shown in FIG. 4, the second surface 54 is formed into a curved surface curved when viewed from a direction along the first axis X. The second surface 54 is formed into an arcuately curved surface concave in the upward direction Y1. The second surface 54 is formed into a curved surface having a recess amount in the upward direction Y1 increasing as approaching the center in the width direction of the projecting portion 52 (direction along the third axis Z).

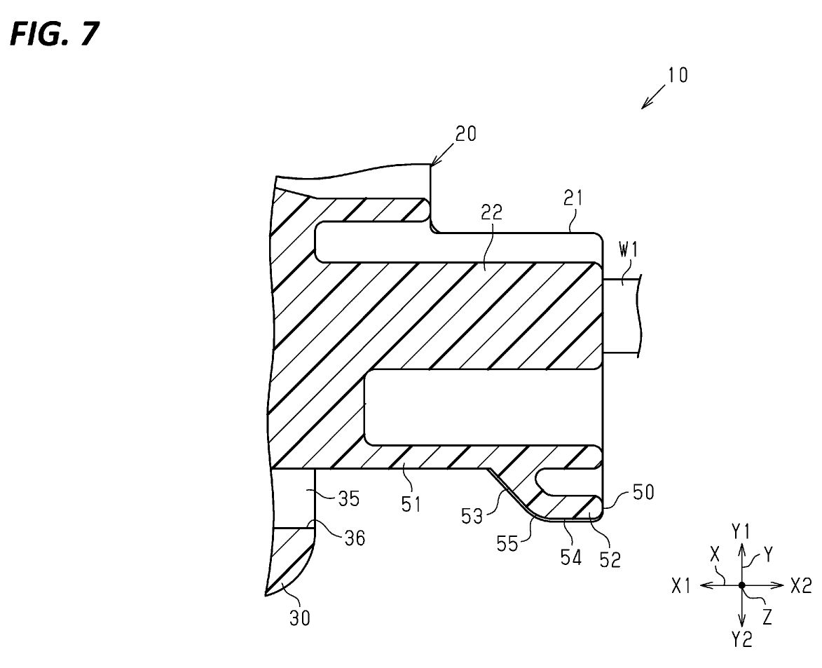

As shown in FIG. 7, the third surface 55 is provided on a corner part between the first and second surfaces 53, 54. The third surface 55 is formed into a curved surface having a round cross-sectional shape obtained by cutting the projecting portion 52 by a plane orthogonal to the third axis Z, i.e. an arcuately curved surface. The third surface 55 of this embodiment is formed into a shape obtained by roundly chamfering the corner part between the first and second surfaces 53, 54.

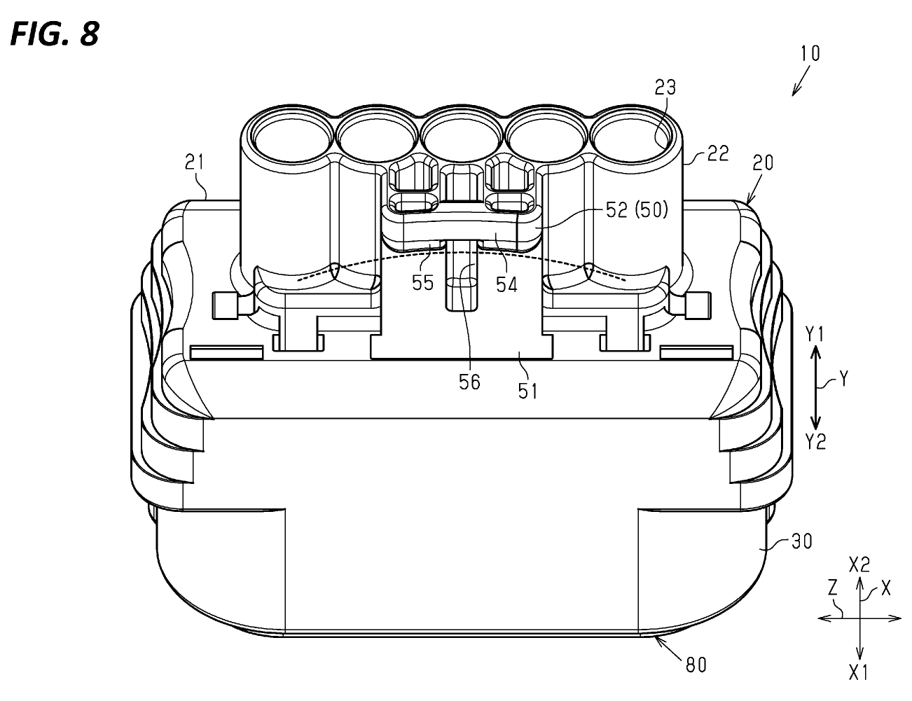

As shown in FIG. 8, the third surface 55 is formed into a curved surface curved when viewed from a direction along the second axis Y. The third surface 55 is formed into an arcuately curved surface concave in the rearward direction X2. The third surface 55 is formed into a curved surface having a recess amount in the rearward direction X2 increasing as approaching the center in the width direction of the projecting portion 52 (direction along the third axis Z).

As shown in FIG. 5, the separating portion 50 includes a groove portion 56. The groove portion 56 is formed to be recessed in the upward direction Y1 from the end surface in the downward direction Y2 of the projecting base 51. The groove portion 56 is provided at a center position in the width direction of the projecting base 51. An axial direction of the groove portion 56 extends along the first axis X. The groove portion 56 extends to the projecting portion 52 to divide the first surface 53 of the projecting portion 52. The groove portion 56 in a part dividing the projecting portion 52 is formed to penetrate through the projecting portion 52 along the second axis Y. The groove portion 56 is formed to divide the first and third surfaces 53, 55 of the projecting portion 52 in the width direction of the projecting portion 52 (third direction). As shown in FIG. 3, inner surfaces of the respective end parts in the axial direction of the groove portion 56 (here, a direction along the first axis X), specifically a first inner surface 57 facing in the forward direction X1 and a second inner surface 58 facing in the rearward direction X2, out of the groove portion 56, are formed to be orthogonal to the axial direction of the groove portion 56.

As shown in FIG. 1, with the first connector 20 and the second connector 80 properly connected, the entire operating portion 43 of the lock arm 40 is exposed to outside and the entire separating portion 50 is exposed to outside.

### Functions of Embodiment

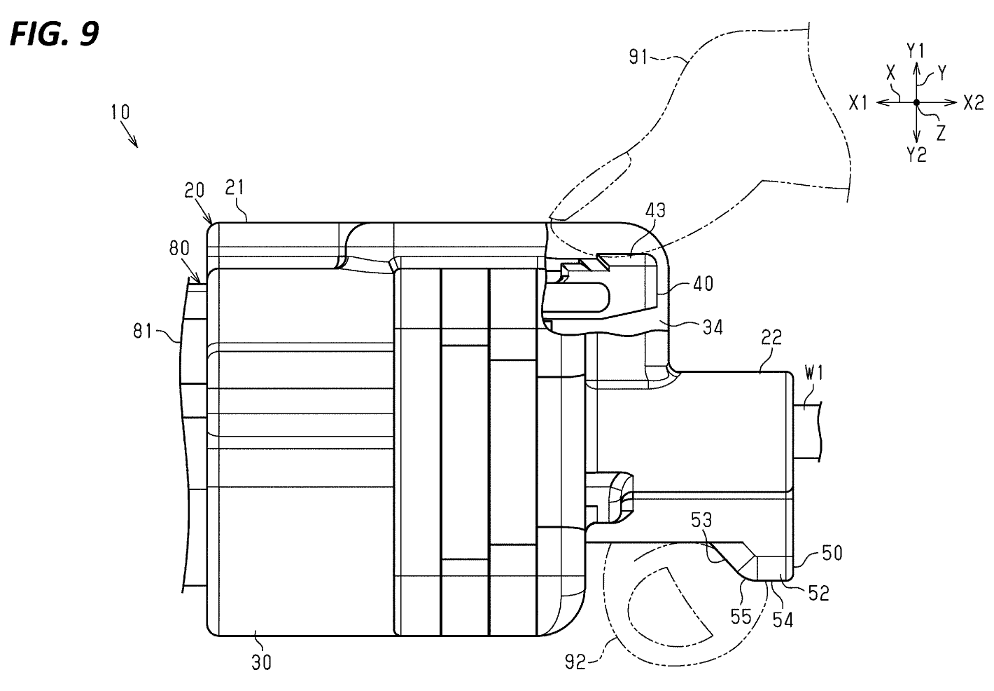

Next, a first method for separating the first connector 20 from the second connector 80 is described in accordance with FIGS. 9 to 11. Note that the housing 21 is shown, partially cut away, to show the operating portion 43 of the lock arm 40 in FIG. 9.

As shown in FIG. 9, in separating the first connector 20 from the second connector 80, a first finger 91 is brought into contact with an end surface in the upward direction Y1 of the operating portion 43 of the lock arm 40 through the cut portion 34 from the rearward direction X2, and a second finger 92 is hooked on the projecting portion 52 of the separating portion 50. Here, the first finger 91 is, for example, a thumb. The second finger 92 is, for example, an index finger. The second finger 92 is so hooked on the projecting portion 52 that a pad part thereof contacts the first and third surfaces 53, 55 of the projecting portion 52 with the tip of the second finger 92 bent to face in a direction along the third axis Z. Then, the first finger 91 is strained to press the operating portion 43 in the downward direction Y2 with the first and second fingers 91, 92 respectively held in contact with the operating portion 43 and the projecting portion 52. By this pressing operation, the lock arm 40 is deflected and deformed with the operating portion 43 as a fulcrum, and an end part in the forward direction X1 of the lock arm 40 is lifted in the upward direction Y1. In this way, a locked state between the lock portion 42 and the lock protrusion 84 shown in FIG. 3 is released. Therefore, the second finger 92 hooked on the projecting portion 52 is strained and the first housing 21 is pulled in the rearward direction X2 while the lock arm 40 is kept deflected and deformed, i.e. the operating portion 43 continues to be pressed by the first finger 91. In this way, the first connector 20 can be separated from the second connector 80. In such a method, since an unlocking operation and a separating operation can be performed as a series of operations, workability is good.

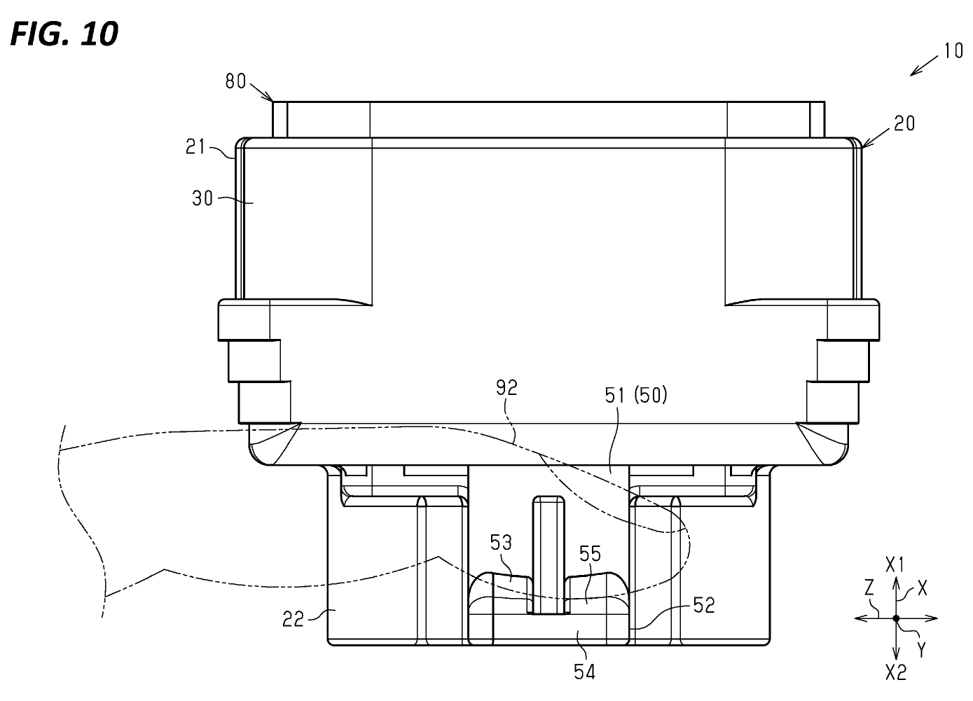

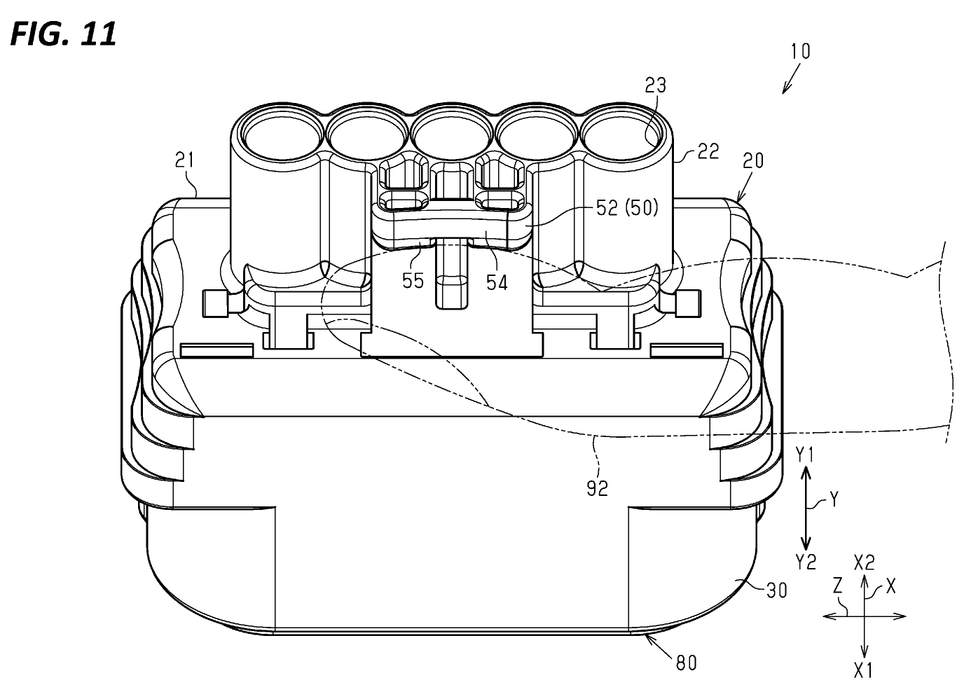

Further, as shown in FIGS. 10 and 11, the pad of the second finger 91 is brought into contact with the first and third surfaces 53, 55 in the above method. At this time, each of the first and third surfaces 53, 55 is formed into the curved surface in conformity with the pad of the second finger 92, specifically the arcuately curved surface concave in the rearward direction X2. Thus, when the first housing 21 is pulled in the rearward direction X2, the pad of the second finger 92 can be widely brought into contact with the first and third surfaces 53, 55, which are the concave curved surfaces. In this way, when the first housing 21 is pulled in the rearward direction X2, a load applied to the second finger 92 can be dispersed and the application of a biased load to the second finger 92 can be suppressed. As a result, the occurrence of a problem that the second finger 92 hurts when the first housing 21 is pulled in the rearward direction X2 can be suitably suppressed, wherefore workability in separating the first connector 20 from the second connector 80 can be improved.

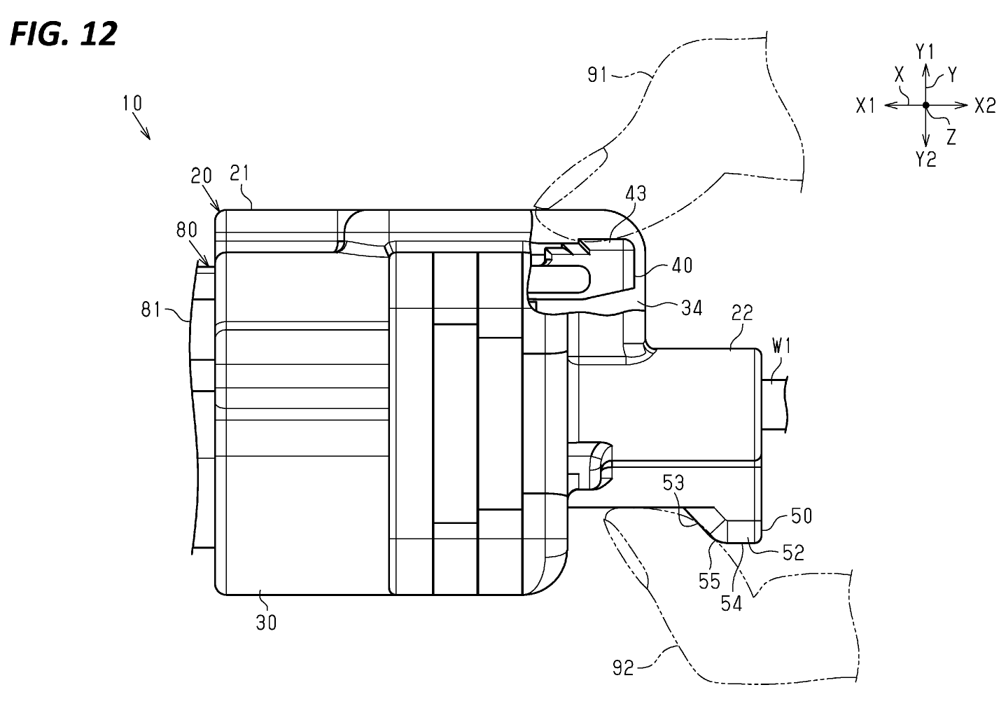

Next, a second method for separating the first connector 20 from the second connector 80 is described in accordance with FIG. 12. Note that the housing 21 is shown, partially cut away, to show the operating portion 43 of the lock arm 40 in FIG. 12.

As shown in FIG. 12, a first finger 91 is brought into contact with the end surface in the upward direction Y1 of the operating portion 43, and a second finger 92 is hooked on the projecting portion 52 of the separating portion 50. The second finger 92 of this example is so hooked on the projecting portion 52 that a pad part of the second finger 92 contacts the first and third surfaces 53, 55 of the projecting portion 52 with the tip of the second finger 92 bent to face in the upward direction Y1. Then, the second finger 92 hooked on the projecting portion 52 is strained and the first housing 21 is pulled in the rearward direction X2 with the lock arm 40 deflected and deformed by pressing the operating portion 43 by the first finger 91. In this way, the first connector 20 can be separated from the second connector 80. At this time, the pad of the second finger 92 can be widely brought into contact with the first and third surfaces 53, 55, which are the concave curved surfaces. In this way, when the first housing 21 is pulled in the rearward direction X2, a load applied to the second finger 92 can be dispersed and the application of a biased load to the second finger 92 can be suppressed. As a result, the occurrence of a problem that the second finger 92 hurts when the first housing 21 is pulled in the rearward direction X2 can be suitably suppressed, wherefore workability in separating the first connector 20 from the second connector 80 can be improved.

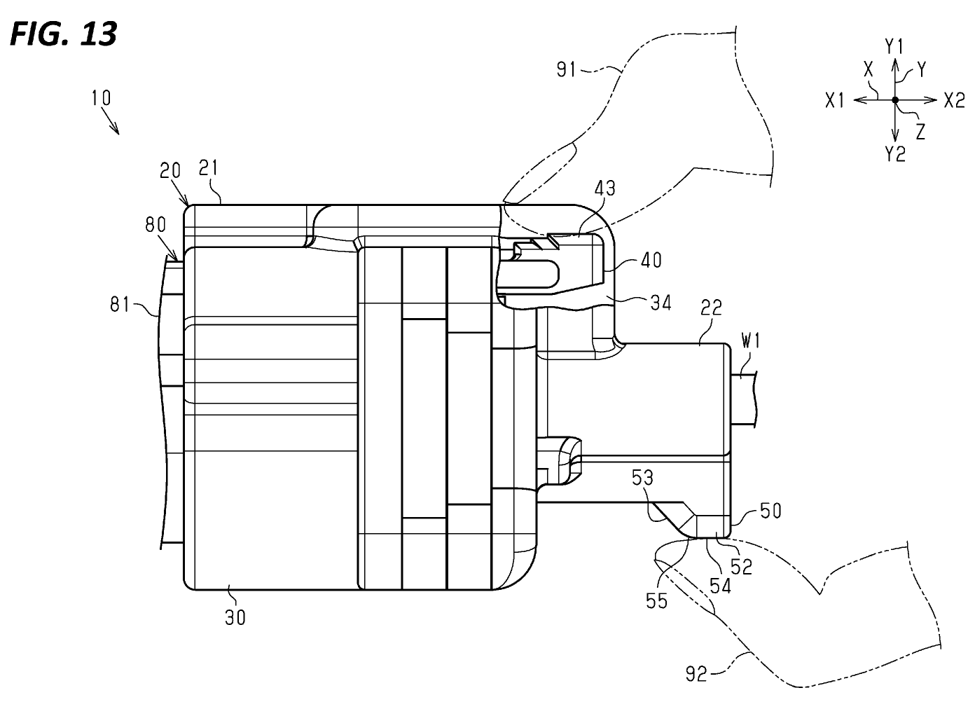

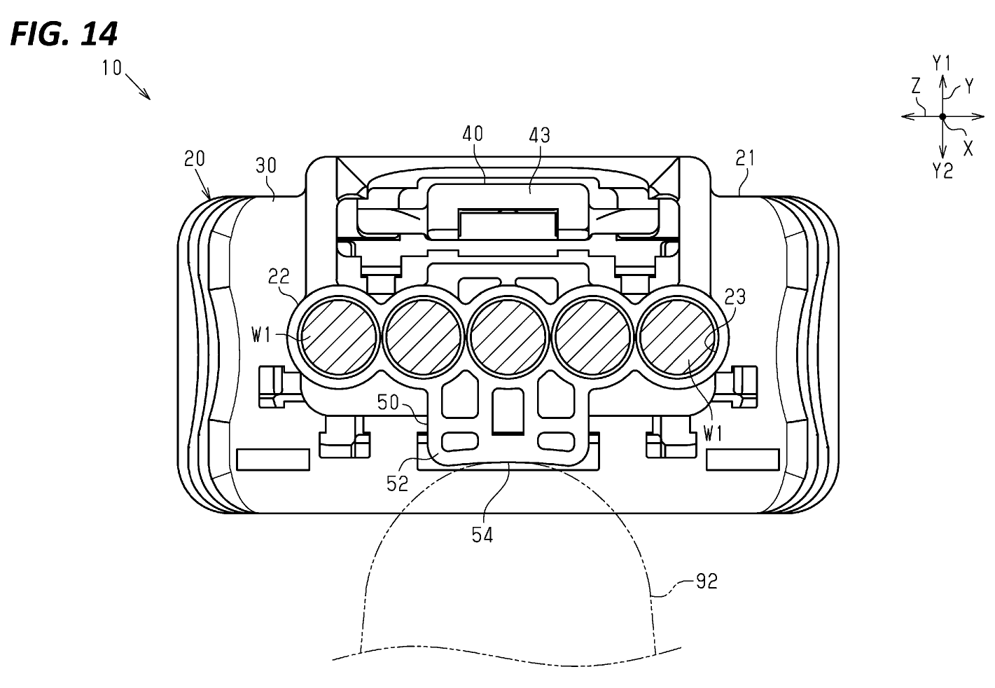

Next, a third method for separating the first connector 20 from the second connector 80 is described in accordance with FIGS. 13 and 14. Note that the housing 21 is shown, partially cut away, to show the operating portion 43 of the lock arm 40 in FIG. 13.

As shown in FIG. 13, a first finger 91 is brought into contact with the end surface in the upward direction Y1 of the operating portion 43, and a second finger 92 is brought into contact with the second surface 54 of the projecting portion 52. In this way, the end surface in the upward direction Y1 of the operating portion 43 and the second surface 54, which is the end surface in the downward direction Y2 of the projecting portion 52, are pinched and sandwiched by the first and second fingers 91, 92. While the lock arm 40 is deflected and deformed by pressing the operating portion 43 by the first finger 91, the second finger 92 is strained and the first housing 21 is pulled in the rearward direction X2 with the first housing 21 pinched by the first and second fingers 91, 92. In this way, the first connector 20 can be separated from the second connector 80. In this example, the tip of the second finger 92 is brought into contact with the second surface 54. Specifically, a tip part of the pad of the second finger 92 is brought into contact with the second surface 54.

At this time, as shown in FIG. 14, the second surface 54 is formed into the curved surface in conformity with the pad of the second finger 92, i.e. the arcuately curved surface concave in the upward direction Y1. Thus, when the first housing 21 is pulled in the rearward direction X2 while being pinched by the first and second fingers 91, 92, a tip part of the pad of the second finger 92 can be widely brought into contact with the second surface 54, which is the concave curved surface. In this way, when the first housing 21 is pulled in the rearward direction X2, a load applied to the second finger 92 can be dispersed and the application of a biased load to the second finger 92 can be suppressed. As a result, the occurrence of a problem that the second finger 92 hurts when the first housing 21 is pulled in the rearward direction X2 can be suitably suppressed, wherefore workability in separating the first connector 20 from the second connector 80 can be improved.

As described above, each of the first, second and third surfaces 53, 54 and 55, which are possibly contacted by the second finger 92 during a separating operation of the first connector 20, is formed into the concave curved surface. Thus, even if the separating operation is performed with the first housing 21 held by various holding ways, the application of a biased load to the second finger 92 can be suitably suppressed.

### Effects of Embodiment

Next, effects of this embodiment are described.
(1) The separating portion 50 provided on the outer surface in the downward direction Y2 (second outer surface) of the housing body 22 includes the projecting portion 52 provided at a position further in the rearward direction X2 than the fitting tube portion 30. The first surface 53 facing in the forward direction X1, i.e. the first surface 53 facing toward the fitting tube portion 30, out of the projecting portion 52, is formed into the curved surface concave in the rearward direction X2 (i.e. the concave curved surface). Thus, the pad of the second finger 92 can be widely brought into contact with the first surface 53, which is the concave curved surface, when the first housing 21 is pulled in the rearward direction X2, for example, with the second finger 92 hooked on the projecting portion 52. In this way, the application of a biased load to the second finger 92 can be suppressed when the first housing 21 is pulled in the rearward direction X2. As a result, the occurrence of a problem that the second finger 92 hurts when the first housing 21 is pulled in the rearward direction X2 can be suitably suppressed, wherefore workability in separating the first connector 20 can be improved.
(2) The first surface 53 of the projecting portion 52 is formed to increase the recess amount in the rearward direction X2 as approaching the center in the width direction of the projecting portion 52 (here, the direction along the third axis Z). Thus, when the second finger 92 is hooked on the projecting portion 52, a central part of the pad of the second finger 92 can be suitably brought into contact with the center in the width direction of the first surface 53. In this way, the second finger 92 can be suitably hooked on the projecting portion 52. Therefore, the first housing 21 can be stably pulled in the rearward direction X2 with the second finger 92 hooked on the projecting portion 52.
(3) The second surface 54 facing in the downward direction Y2, out of the projecting portion 52, is formed into the curved surface concave in the upward direction Y1. Thus, when the first housing 21 is pulled in the rearward direction X2 with the lock arm 40 and the projecting portion 52 pinched and sandwiched by the first and second fingers 91, 92, the tip part of the pad of the second finger 92 can be widely brought into contact with the second surface 54, which is the concave curved surface. In this way, the application of a biased load to the second finger 92 can be suppressed when the first housing 21 is pulled in the rearward direction X2.
(4) The third surface 55 provided on the corner part between the first and second surfaces 53, 54, out of the projecting portion 52, is formed into the curved surface concave in the upward direction Y1. Thus, when the first housing 21 is pulled in the rearward direction X2 with the second finger 92 hooked on the projecting portion 52, the pad of the second finger 92 can be brought into contact with the third surface 55, which is the concave curved surface. In this way, the application of a biased load to the second finger 92 can be suppressed when the first housing 21 is pulled in the rearward direction X2.

### Application Example of Connector 10

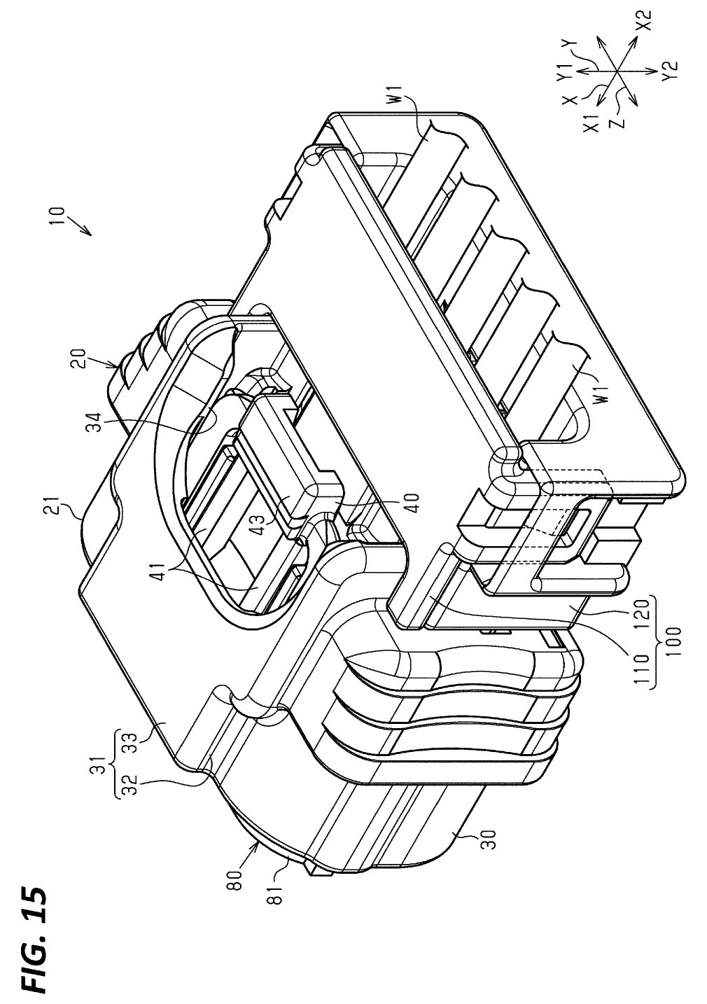

Next, an application example of the connector 10 is described in accordance with FIGS. 15 to 18.

As shown in FIG. 15, a wire cover 100 can be mounted on the first connector 20. The wire cover 100 is mounted on an end part in the rearward direction X2 of the housing body 22. The wire cover 100 protects the wires W1 pulled out in the rearward direction X2 from the housing body 22. Further, the wire cover 100 restricts a pull-out direction of the wires W1 pulled out from the housing body 22.

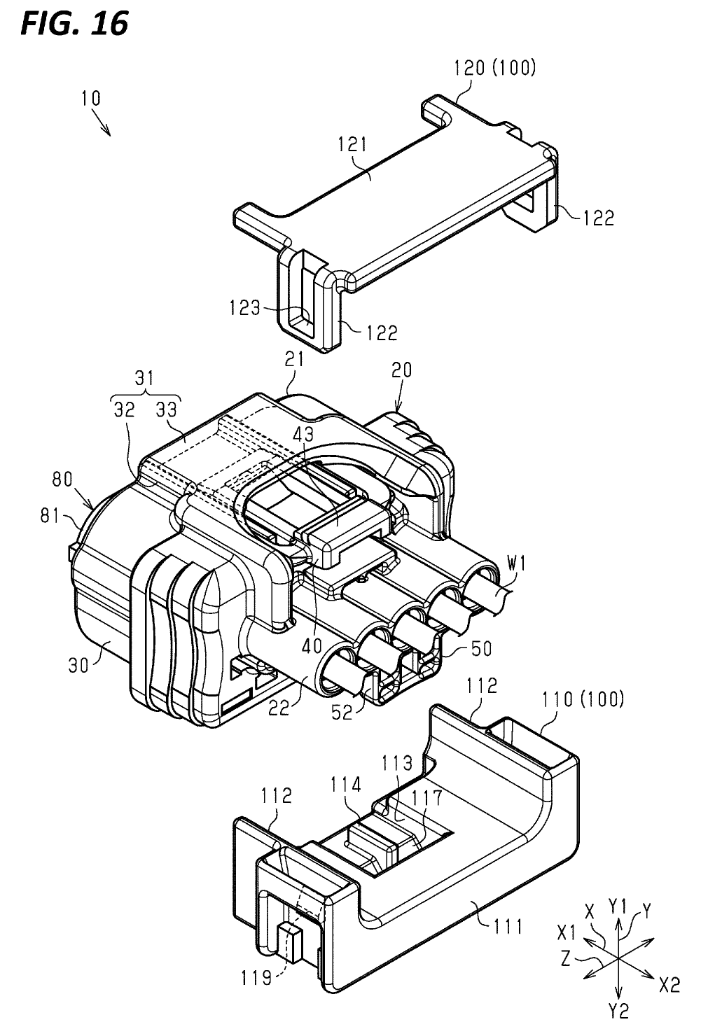

As shown in FIG. 16, the wire cover 100 includes a receiving portion 110 and a lid portion 120 formed to be attachable to and detachable from the receiving portion 110. The receiving portion 110 and the lid portion 120 are, for example, separate components. The lid portion 120 is assembled with the receiving portion 110 along the downward direction Y2. The wire cover 100 is formed into a tubular shape to surround the outer periphery of the end part in the rearward direction X2 of the housing body 22 over an entire periphery in a circumferential direction by uniting the receiving portion 110 and the lid portion 120. The wire cover 100 configured into a tubular shape is open in the forward direction X1 and open in the rearward direction X2. Each of the receiving portion 110 and the lid portion 120 is made of synthetic resin. Note that the receiving portion 110 and the lid portion 120 may be made of the same type of material or may be made of mutually different materials.

The receiving portion 110 is formed into a half tube shape as a whole. The receiving portion 110 includes a bottom wall 111 facing the lid portion 120 and two side walls 112 projecting toward the lid portion 120 from both side edges of the bottom wall 111. The receiving portion 110 is open in the upward direction Y1.

A first recess 113 recessed in the downward direction Y2 is provided in an inner surface facing the lid portion 120 in the second axis Y, out of the bottom wall 111, i.e. an end surface in the upward direction Y1 of the bottom wall 111. The first recess 113 is provided at a center position of the bottom wall 111 in the third axis Z. The first recess 113 is provided to face the separating portion 50 of the first housing 21 in the second axis Y. The first recess 113 is formed in such a size that the projecting base 51 (see FIG. 5) of the separating portion 50 is fittable thereinto.

A ridge portion 114 projecting in the upward direction Y1 from the bottom surface of the first recess 113 is provided on that bottom surface. A length direction of the ridge portion 114 extends along the first axis X. The ridge portion 114 is provided at a center position of the first recess 113 in the third axis Z.

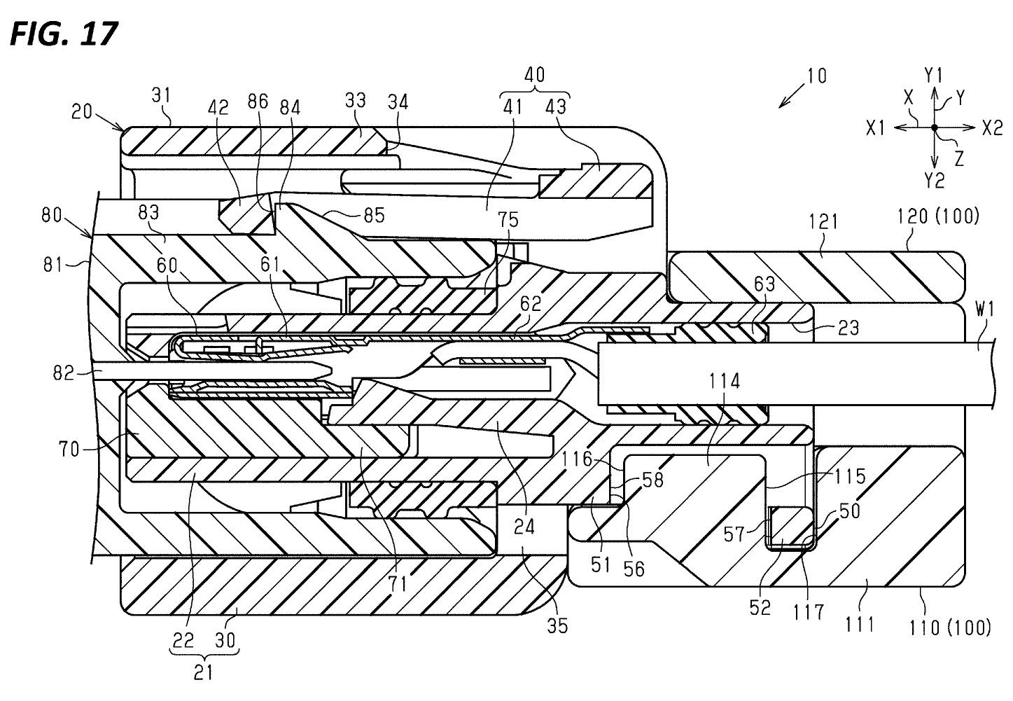

As shown in FIG. 17, the ridge portion 114 is formed to be fittable into the groove portion 56 of the separating portion 50. The ridge portion 114 is fit into the groove portion 56 along the upward direction Y1. By fitting the ridge portion 114 into the groove portion 56, the receiving portion 110 can be positioned with respect to the housing body 22. End surfaces in the length direction of the ridge portion 114, specifically a first end surface 115 facing in the rearward direction X2 and a second end surface 116 facing in the forward direction X1, out of the ridge portion 114, are formed to be orthogonal to the length direction of the ridge portion 114 (here, a direction along the first axis X). The first end surface 115 is provided to face the first inner surface 57 of the groove portion 56 in the first axis X. The first end surface 115 is engageable with the first inner surface 57 in the first axis X. The second end surface 116 is provided to face the second inner surface 58 of the groove portion 56 in the first axis X. The second end surface 116 is engageable with the second inner surface 58 in the first axis X.

As shown in FIG. 16, a second recess 117 recessed in the downward direction Y2 from the bottom surface of the first recess 113 is provided in that bottom surface. The second recess 117 is provided in an end part in the rearward direction X2 of the first recess 113.

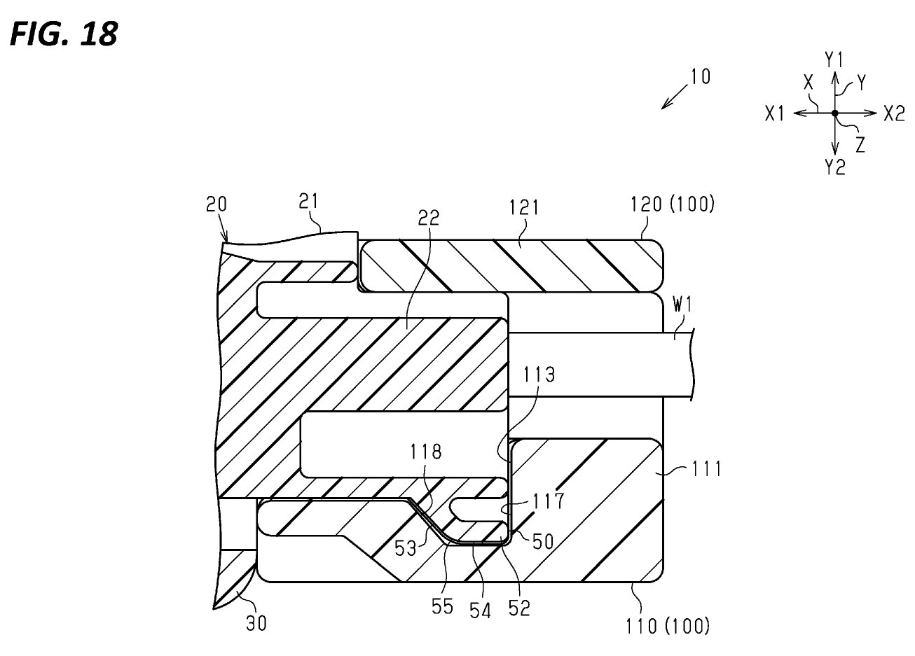

As shown in FIG. 18, the second recess 117 is so formed that the projecting portion 52 of the separating portion 50 is fittable thereinto. A third inner surface 118 facing in the rearward direction X2, out of the second recess 117, is provided to face the first surface 53 of the projecting portion 52 in the first axis X. The third inner surface 118 is formed to be inclined to correspond to the inclination of the first surface 53. The third inner surface 118 is formed to be inclined toward the rearward direction X2 from the bottom surface of the first recess 113 toward the bottom surface of the second recess 117.

As shown in FIG. 16, the respective side walls 112 are continuously and integrally formed with the bottom wall 111. The respective side walls 112 project in the upward direction Y1 respectively from both end edges in the third axis Z of the bottom wall 111. The respective side walls 112 are, for example, facing each other in the third axis Z.

The receiving portion 110 includes one or more first engaging portions 119. The first engaging portion 119 is provided on the outer surface of the side wall 112. The first engaging portion 119 is a projection projecting outward from the outer surface of the side wall 112.

The lid portion 120 includes a lid body 121 and one or more second engaging portions 122. The lid body 121 is formed to close an opening in the upward direction Y1 of the receiving portion 110. The lid body 121 is provided to face the bottom wall 111 and the two side walls 112 in the second axis Y. The lid body 121 is in the form of a plate.

The second engaging portion 122 is provided to face the first engaging portion 119 of the receiving portion 110. The second engaging portion 122 is formed to be engageable with the first engaging portion 119. The second engaging portion 122 is a resilient piece projecting toward the first engaging portion 119 and formed to be resiliently deformable along the third axis Z. The second engaging portion 122 is, for example, formed into a rectangular frame body and includes an engaging hole 123 engageable with the first engaging portion 119 in a center of the rectangular shape. A united state of the receiving portion 110 and the lid portion 120 is maintained by the engagement of the first and second engaging portions 119, 122.

Here, as shown in FIG. 17, with the wire cover 100 mounted on the housing body 22, the entire operating portion 43 of the lock arm 40 is exposed to outside and the entire separating portion 50 is covered by the wire cover 100.

Next, an example of a method for separating the first connector 20 from the second connector 80 is described with reference to FIGS. 17 and 18.

First, if the wire cover 100 is mounted on the housing body 22, the ridge portion 114 of the wire cover 100 is fit into the groove portion 56 of the separating portion 50 and the projecting portion 52 of the separating portion 50 is fit into the second recess 117 of the wire cover 100. In this way, the first end surface 115 facing in the rearward direction X2 of the ridge portion 114 and the first inner surface 57 facing in the forward direction X1 of the groove portion 56 are engaged with each other in the first axis X. Thus, if the wire cover 100 is pulled in the rearward direction X2 with the operating portion 43 pressed, the first housing 21 can be pulled in the rearward direction X2, together with the wire cover 100, by the engagement of the first end surface 115 and the first inner surface 57.

As just described, in the connector 10 of this application example, the first connector 20 can be separated from the second connector 80 with the wire cover 100 mounted on the housing body 22. In this way, an operation of removing the wire cover 100 from the housing body 22 can be omitted, wherefore workability in separating the first connector 20 can be improved as compared to the case where the removing operation of the wire cover 100 is necessary in separating the first connector 20.

### Modifications

The above embodiment can be modified and carried out as follows. The above embodiment and the following modifications can be combined with each other and carried out without technically contradicting.

The structure of the wire cover 100 in the above embodiment can be changed as appropriate. For example, the structure of the wire cover 10 can be changed as appropriate according to a routing path of the wires W1.

Although the receiving portion 110 and the lid portion 120 are constituted by separate components in the wire cover 100 of the above embodiment, there is no limitation to this. For example, the receiving portion 110 and the lid portion 120 may be integrally formed via a hinge or the like.

The wire cover 100 in the above embodiment may be omitted.

Although the groove portion 56 is formed to extend to the projecting portion 52 to divide the first surface 53 in the above embodiment, there is no limitation to this. For example, the groove portion 56 may be provided only in the projecting base 51, out of the projecting base 51 and the projecting portion 52.

The groove portion 56 in the separating portion 50 of the above embodiment may be omitted.

The projecting base 51 in the separating portion 50 of the above embodiment may be omitted. The projecting portion 52 in this case is formed to project in the downward direction Y2 from the end surface in the downward direction Y2 of the housing body 22.

The structure of the projecting portion 52 of the above embodiment can be changed as appropriate.

Although the second surface 54 of the projecting portion 52 is formed into the curved surface concave in the upward direction Y1 when viewed from the direction along the first axis X in the above embodiment, there is no limitation to this. For example, the second surface 54 may be formed into a flat surface extending straight along the third axis Z when viewed from the direction along the first axis X.

Although the third surface 55 of the projecting portion 52 is formed into the curved surface concave in the rearward direction X2 when viewed from the direction along the second axis Y in the above embodiment, there is no limitation to this. For example, the third surface 55 may be formed into a flat surface extending straight along the third axis Z when viewed from the direction along the second axis Y.

In the above embodiment, the number of the first terminal fittings 60 held in the first housing 21 can be changed as appropriate.

Although the first connector 20 is embodied as a female connector and the second connector 80 is embodied as a male connector in the above embodiment, there is no limitation to this. For example, the first connector 20 may be embodied as a male connector and the second connector 80 may be embodied as a female connector.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A connector, comprising a first connector including a first housing and a first terminal fitting held in the first housing,
the first housing including:
a housing body for accommodating the first terminal fitting inside;
a fitting tube portion surrounding an outer periphery of the housing body;
a lock arm provided at a position further in a first direction than a first outer surface of the housing body; and
a separating portion provided on a second outer surface opposite to the first outer surface, out of the housing body,
the separating portion including a projecting portion projecting in a first opposite direction opposite to the first direction,
the projecting portion being provided at a position further in a second direction intersecting the first direction than the fitting tube portion,
the projecting portion having a first surface facing in a second opposite direction opposite to the second direction, and
the first surface being formed into an arcuately curved surface concave in the second direction when viewed from the first opposite direction.

2. The connector of claim 1, wherein:
the projecting portion has a width extending along a third direction intersecting both the first direction and the second direction, and
the first surface is formed into a curved surface having a recess amount in the second direction increasing toward a center in the third direction.

3. The connector of claim 2, wherein:
the projecting portion has a second surface facing in the first opposite direction, and
the second surface is formed into an arcuately curved surface concave in the first direction when viewed from the second direction.

4. The connector of claim 3, wherein:
the projecting portion has a third surface provided on a corner part between the first surface and the second surface, and
the third surface is formed into an arcuately curved surface concave in the second direction when viewed from the first opposite direction.

5. The connector of claim 3, wherein:
the separating portion includes a projecting base provided on the second outer surface, the projecting portion projecting in the first opposite direction from an end surface in the first opposite direction of the projecting base and a groove portion recessed in the first direction from the end surface in the first opposite direction of the projecting base,
the first surface is formed to be inclined toward the second direction from the end surface in the first opposite direction of the projecting base toward the second surface,
an axial direction of the groove portion extends along the second direction,
the groove portion extends to the projecting portion to divide the first surface in the third direction, and
a first inner surface facing in the second opposite direction, out of the groove portion, extends orthogonally to the second direction.

6. The connector of claim 5, further comprising a wire cover to be mounted on the outer periphery of the housing body, wherein:
the wire cover includes a ridge portion to be fit into the groove portion,
a length direction of the ridge portion extends along the second direction, and
a first end surface facing in the second direction, out of the ridge portion, is formed to extend orthogonally to the second direction and be engageable with the first inner surface of the groove portion.

7. The connector of claim 1, further comprising a second connector, the first connector being attached to and detached from the second connector, wherein:
the second connector includes a second housing to be fit to the first housing and a second terminal fitting to be electrically connected to the first terminal fitting, and
the second housing includes a receptacle to be fit between the housing body and the fitting tube portion and a lock protrusion projecting from an outer surface of the receptacle and engageable with the lock arm.
